(19) United States
(12) Patent Application Publication
(10) Pub. No.: US 2006/0253397 A1
(43) Pub. Date: Nov. 9, 2006

(54) Business model and software

(76) Inventors: Omar Merchan Gomez, Buenos Aires (AR); Anibal Horacio Sanchez, Buenos Aires (AR); Ariel Marcelo Jadzinsky, Buenos Aires (AR); Gustavo Laureano Merchan, Buenos Aires (AR)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 11/402,359

(22) Filed: Apr. 12, 2006

Related U.S. Application Data
(60) Provisional application No. 60/670,387, filed on Apr. 12, 2005.

(51) Int. Cl. G06Q 99/00

(52) U.S. Cl. 705/50

(57) ABSTRACT

Disclosed is a Framework that applies object-oriented state-machine techniques to provide automation, control, and operation of business processes. The Framework provides a working environment from which software applications are created and customized. A visual modeling tool provides an end user with an intuitive and simple way to model processes. Once the model is imported into a database, an Engine automates the process, assigning tasks to users in order to control the accomplishment of each task. The Builder is a customization tool that allows fields or attributes to be customized, defines displays, policies, and business rules, and generates system-initialization data for each application. A Software Development Kit allows the development of applications with specific needs. A Business Model allows distributors to implement applications with the Builder and to obtain earnings both from direct sales of their applications and from royalties for the use and sale of their applications by other distributors.

### CROSS-REFERENCE TO RELATED APPLICATION

This application claims priority to U.S. Provisional Patent Application 60/670,387, “Business Model and Software,” which was filed on Apr. 12, 2005, and which is incorporated herein in its entirety by reference.

### FIELD OF THE INVENTION

The present invention relates generally to automation control software and, more particularly, to applying finite-state machines to Business Process Management Systems (“BPMS”) in enterprises and in organizations.

### BACKGROUND OF THE INVENTION

Several techniques have become entrenched for automating and controlling business processes. The majority of current products are based on either ANSI (American National Standards Institute) process-flow diagrams (e.g., Documentum) or Petri Nets (e.g., Staffware).

Joining these two techniques is the emerging technology of Object-Oriented Petri Nets (“OOPN”). OOPN takes the whole Petri Net as an object to help solve problems that typically appear in workflow version management. Different workflow versions are modeled as variations of each other. The new version inherits a common part from the old version by applying workflow inheritance. Appropriate workflow “soundness” is achieved by using well defined rules that apply to token migration from the old version to the new one. “Soundness” here includes the absence of many workflow problems including task duplication, task omission, and deadlocks or livelocks.

None of these techniques, not even OOPN, has proven to be entirely satisfactory for BPMS applications.

### BRIEF SUMMARY OF THE INVENTION

In view of the foregoing, the present invention provides a BPMS Framework that applies object-oriented state-machine techniques to provide automation, control, and operation of business processes. The management of a process is modeled by a diagram of states and events, according to finite-state-machine theory. As events occur, the process travels through the states defined in the diagram.

The BPMS Framework of the present invention provides a working environment from which software applications are created and customized. Embodiments of the BPMS Framework include all or some of the following elements.

A visual modeling tool provides an end user with an intuitive and simple way to model processes. Because the present invention uses an open architecture which allows for easy integration, the end user may choose any of several commercially available business process visualization tools such as Microsoft OFFICE VISIO®.

Once the model is imported into a database, an Engine automates the process, assigning tasks to hundreds or thousands of users in order to control the accomplishment of each and every task. The Engine decides the next task according to the model. At the same time, in order to perform automatic tasks the engine interacts with other systems and decides which actions to take based on the results of the automatic actions.

The Builder is a customization tool for BPMS applications. It is a visual tool that includes a wizard to define business objects and thus does not require any knowledge of systems or programming. Among other things, it allows fields or attributes to be customized, defines displays, policies, and business rules, and it generates system-initialization data for each BPMS application. The Builder generates code, compiles it, and installs the application on a server machine, ready to be used. It also provides system-customization maintainability.

A Software Development Kit (“SDK”) allows the development of new applications with specific needs. The SDK is a set of documented libraries and open source code that allows a system developer to extend the functionality of applications without limit.

The present invention provides a Business Model that relies on a Techno-Comm Network. The Network allows franchisees to develop new applications with the SDK. The Business Model allows distributors to implement the applications with the Builder. The commercial advantage for the franchisees is that they will not only obtain earnings from direct sales of their developed applications to their own customers, but they will also receive royalties for the use and sale of their developed applications by other distributors who are members of the Techno-Comm Network.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of exemplary stencils that allow objects to be dragged into a model to simply design a process; the objects have attributes and can be edited;

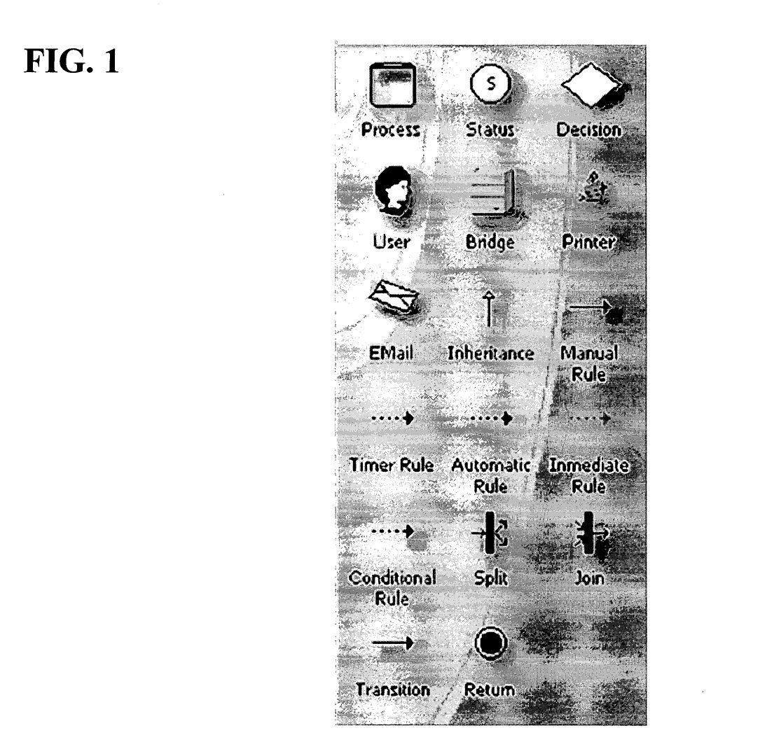

FIG. 2 is a process diagram showing exemplary objects according to the present invention;

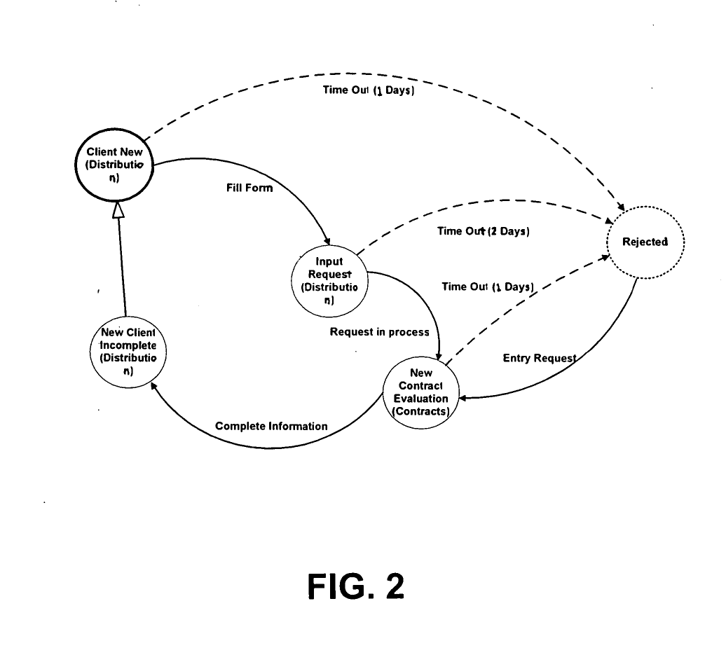

FIG. 3 is a process diagram showing business process rules or “strategies” which are defined by an origin status, a destination status, and an event that causes a transition between the statuses;

FIG. 4 is a process diagram illustrating that each process rule may have a series of parameters defined as actions that are executed for each token that travels the process rule;

FIG. 5 is a process diagram emphasizing an object-oriented, state-machine status hierarchy;

FIG. 6 is a set of object-relationship diagrams that illustrate inheritance rules;

FIG. 7 is a process diagram showing overwrite;

FIG. 8 is an object-relationship diagram illustrating a work-list hierarchy;

FIG. 9 is a table of user-to-work-list relationships;

FIG. 10 is an object-relationship diagram showing token assignment to work-lists;

FIG. 11 is a process diagram showing how the Builder and the SDK are used in the development process;

FIG. 12 is an object-relationship diagram of an abstract customization scheme;

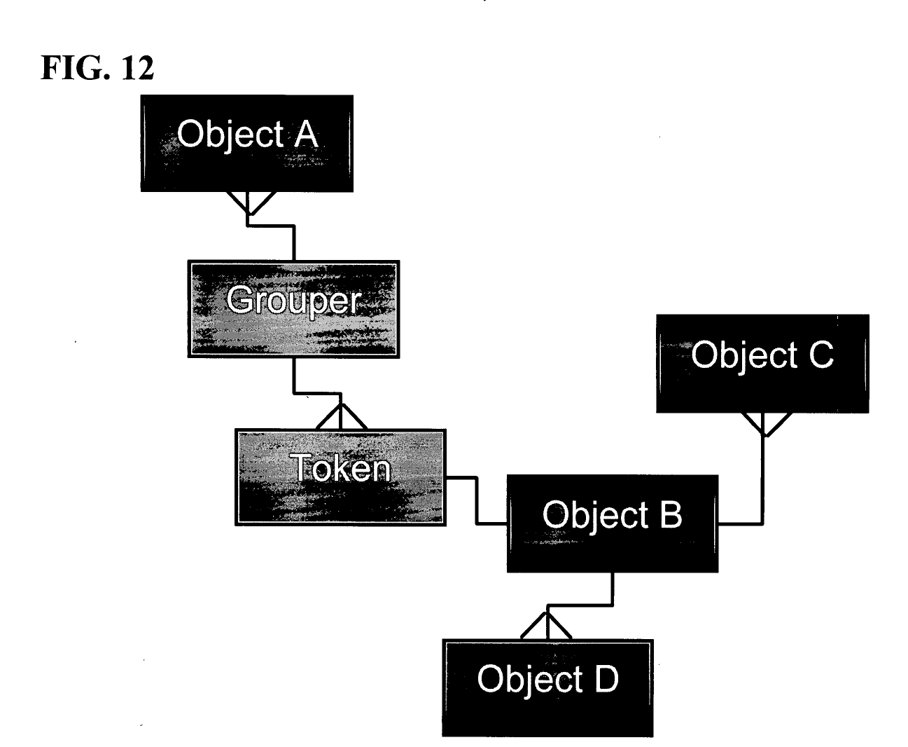

FIG. 13 is an object-relationship diagram of a possible data-model configuration;

FIG. 14 is an object-relationship diagram of another possible data-model configuration;

FIG. 15 is an object-relationship diagram showing that entities of a possible data model can reside in other systems;

FIG. 16 is a schematic diagram of a distributed data model;

FIG. 17 is a user-interface view of a customized management consolidated screen with information coming from distributed data sources; the Builder allows the assembly of consultations according to a virtual base and customizes management screens;

FIG. 18 is a process diagram showing affiliations in an example of a dynamic forms utility; two rules (origin status, destination status, transitional event) are illustrated;

FIG. 19 is a user-interface view showing two events available as options when a user registers his management;

FIG. 20 is a user-interface view showing how different events hide different dynamic forms, each with its own data structure, defaults, and validations;

FIG. 21 is a process diagram illustrating the utility of the standard parameter “operation” associated with the status;

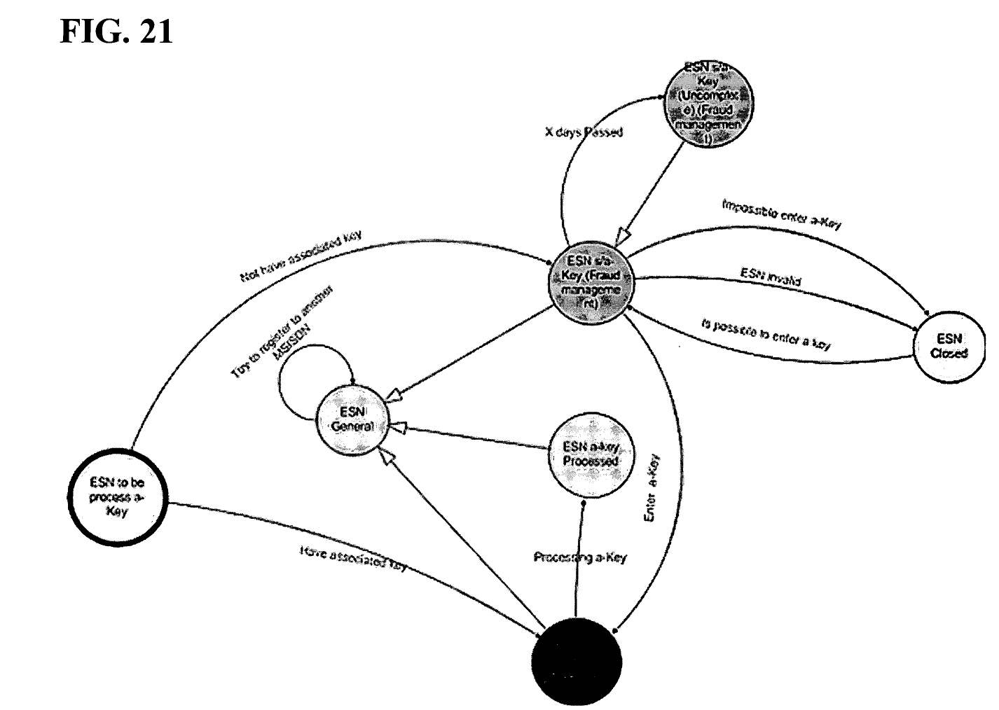

FIG. 22 is a process diagram showing the status of an operation consumed by an automatic process;

FIG. 23 is a process diagram showing a Short Message Service (“SMS”) text message sent to warn that a credit limit has been overcome;

FIG. 24 is a process diagram of a sale/offer process;

FIG. 25 is a schematic diagram of the three layers of members of the Techno-Comm Network: the company in the center coordinates, documents, and manages release development; franchisees develop new applications; and distributors integrate systems with the applications;

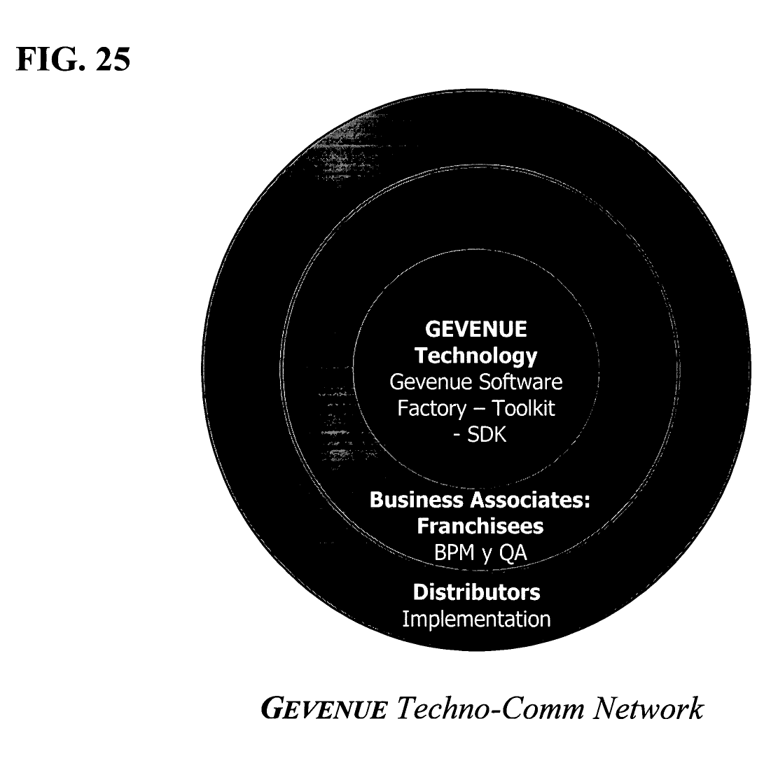

FIG. 26 is a schematic diagram comparing object-oriented state machines of the present invention with standard ANSI flow charts;

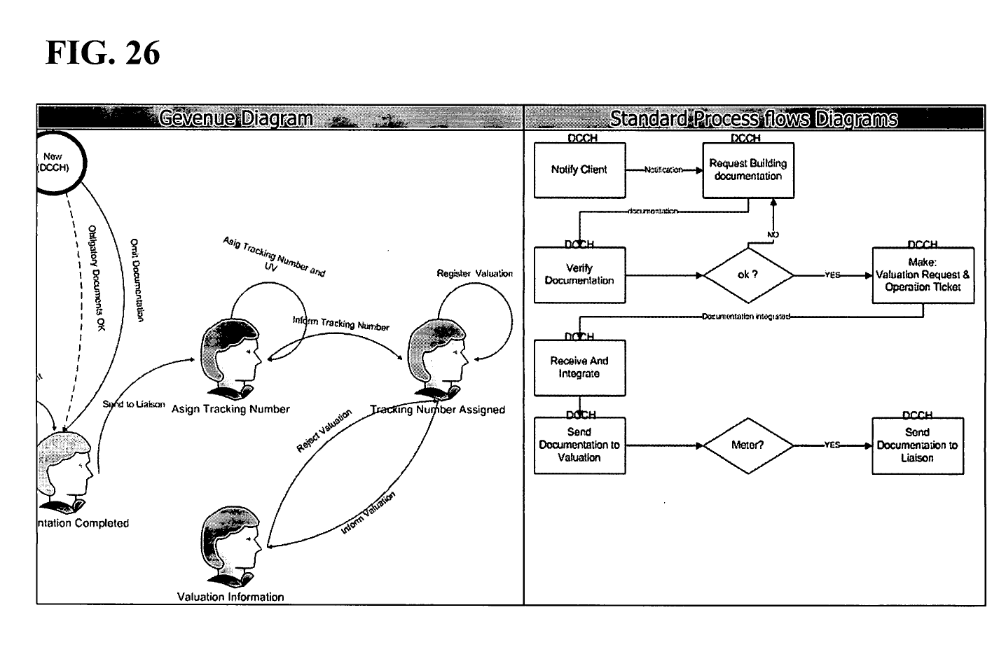

FIG. 27 is a schematic diagram comparing state-machine workflows of the present invention with Petri Nets; and

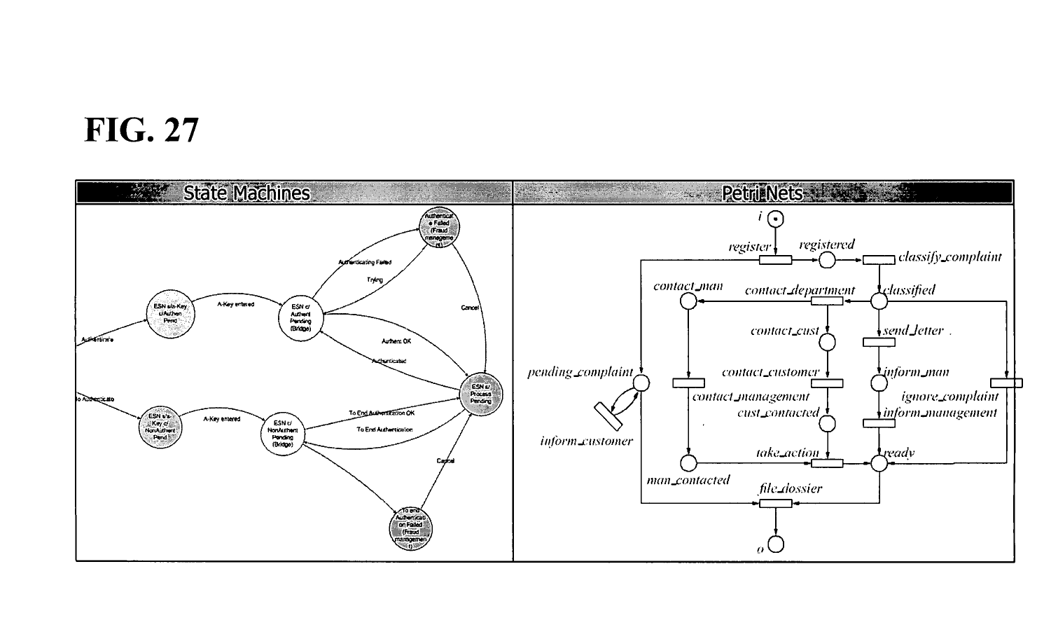

FIG. 28 is a schematic diagram of different levels of token subsets: the highest group is the universe of tokens, the lowest group corresponds to an agenda; a user has more permission the farther down he goes in the group hierarchy.

### DETAILED DESCRIPTION OF THE INVENTION

Turning to the drawings, wherein like reference numerals refer to like elements, the present invention is illustrated as being implemented in a suitable environment. The following description is based on embodiments of the invention and should not be taken as limiting the invention with regard to alternative embodiments that are not explicitly described herein.

Basic Concepts of Business Processes

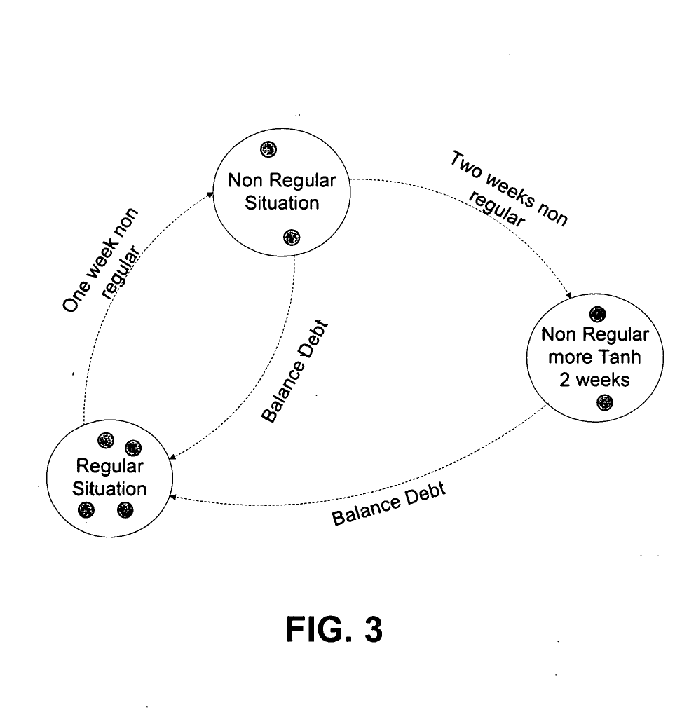

The BPMS Engine is based on the intelligent control of business process rules that are applied to each business process instance (“token”). See FIG. 3. A token is an object that evolves within an instance of a process. A token represents an activity or task to perform. Examples of tokens are: an instance of customer care, a document to manage, a request for information, a project requirement, a production order, a purchase order, a sales offer, a complaint for a repair ticket, and a collection complaint.

A token is related to only one client or “grouper” of a process. The grouper is the one who is interested in receiving a service from the process. In this sense, the grouper is the “owner” of the process. The following are examples of groupers and tokens:
Collections: The client is the grouper, and a token represents a complaint.
Sales: The client is the grouper, and a token represents an offer.
Requirements: The project is the grouper, and a token represents a task.
Purchases: The provider is the grouper, and a token represents an order.
   Note that a complaint or offer is always related to a client. A client could register one or more complaints. Then, the grouper has more than one associated token in the same process. It could even be the case that a client could group complaints and offers in different processes. Every time CRM (Customer Relationship Management) problems are modeled, the grouper is the client of the company. In the Requirements and Purchases examples above, the groupers are not clients. In a purchase process, the grouper could be a supplier.

Business-process rules are defined by establishing states and events. See, for example, FIG. 3. The events represent possible transitions between states by which the management of tokens within a business process can evolve. These business rules can be applied manually and automatically. “Manually” here means “by a user.” The user generates status transitions (manual events), registering the corresponding event according to the management performed as indicated by the token. “Automatically” here means “by the system without manual intervention.” The status of the token changes for any internal event such as the arrival of a due date, an automatic data entry from another system that implies a transition, warnings, expirations, commands, logic conditions, and the like. Automatic events (status transitions) depend upon what is defined as part of the business rules.

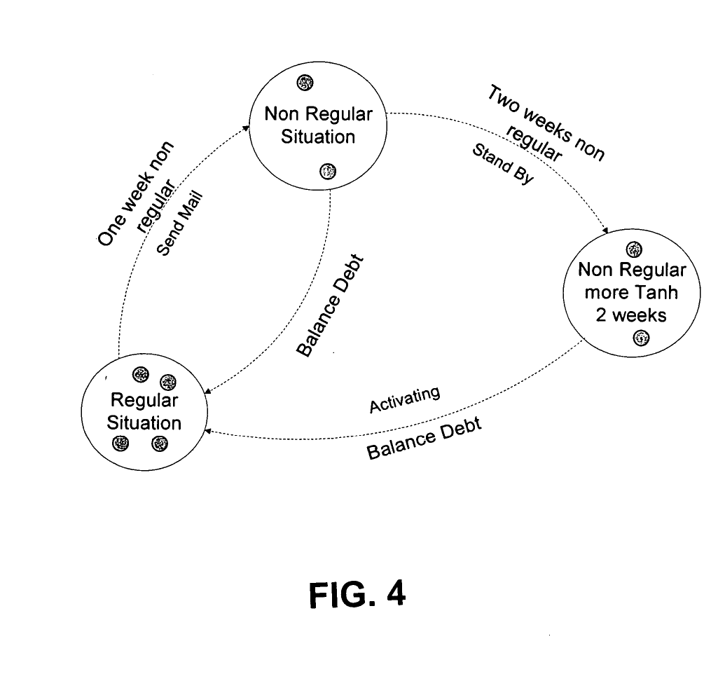

For each business rule, actions to other systems can be added. See FIG. 4. In addition, communications to the process client, warnings to other system users (supervisors), system data entries, and execution conditions or permissions can be added to each defined business rule.

Multiple processes can be configured for different subgroups of tokens according to diverse token segmentation. Multiple processes can also be configured for parallel processes when simultaneous management of multiple faces of the token is required, for example, for multiple users doing parallel tasks or for an application that controls any particular property of the tokens automatically.

An Object-Oriented Modeling Tool: Description

Business-process charts according to the present invention borrow from object-oriented technology. These charts support the following:
Status Hierarchy: Statuses can be represented in a hierarchy, so that a status can have a parent, or equally, a status may inherit from another status.
Inherited Rules According to Status Hierarchy: A status that inherits from another inherits every outbound rule applied to the father status and to the grandfather status.
Similarity to Object-Oriented (“OO”) Technology: OO technology provides both for classes with hierarchies and for methods inherited from a super-class to a sub-class. In the present invention, classes are the statuses, and methods are the rules (graphically represented by outbound arrows).
Overwrite or Redefinition of Rules as in OO Technology: In the present invention, a child status may contain the same outbound rules as its parent. In that case as in an OO machine, the Engine is intelligent and looks to the first existing rule from bottom to top, meaning that a local status outbound rule prevails over an inherited rule.
Polymorphism: (see section below).

An Object-Oriented Modeling Tool: Status Hierarchy

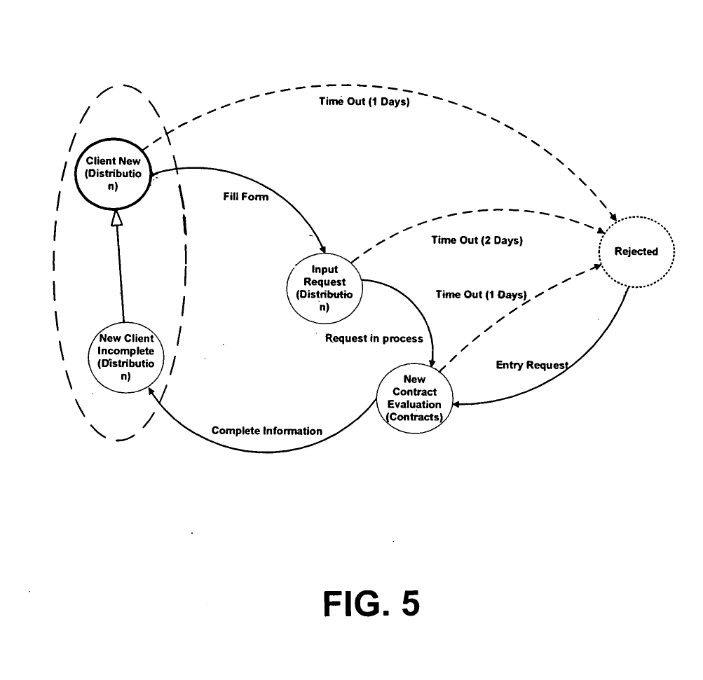

In FIG. 5, two circles encompassed by the dotted oval show a representation of rule legacy. The New Unfulfilled Client status is a child of the New Client status. The hierarchy is represented by an arrow with a triangular end.

An Object-Oriented Modeling Tool: Inherited Rules

Once a hierarchy has been represented, inherited outbound rules come into play. In the Figures, outbound rules are represented by arrows. When a rule is fulfilled, the task or token moves from one status to other. In the present invention, a child bubble (status) inherits its parent's rules. FIG. 5 shows a father bubble (status) with an outbound rule named Data Entry. Consequently, the child bubble also has this outbound rule even if it is not explicitly drawn in the diagram: the rule is inherited. It would be redundant to write a rule with origin status New Unfulfilled Client, destiny status Tray of Requests, and event Data Entry.

According to the example of FIG. 5, inherited outbound rules provide that if a token is either in father status or in child status, it could change to the Tray of Requests status through the outbound rule with event Data Entry.

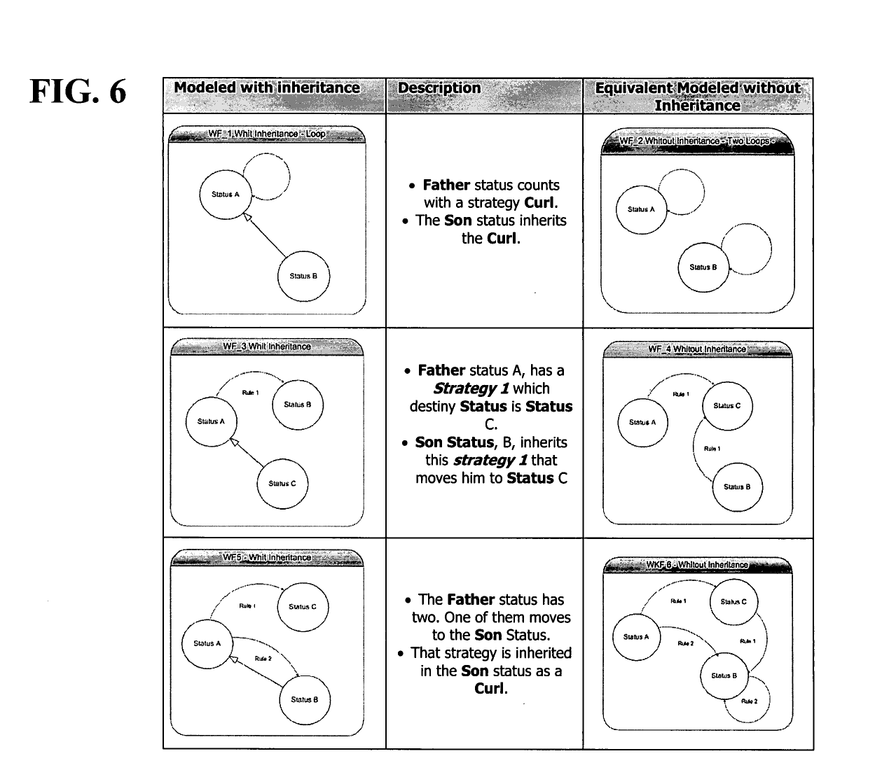

Next are three modeling situations with status hierarchies and modeling methods where inherited rules do not apply. See FIG. 6.

Note: In the Figures, the word “strategy” is synonymous with “rule.”

It is important to note that this concept not only applies to inherited but also to unlimited status hierarchies. Sons, grandsons, and as many inheritance levels as required can be modeled. Statuses inherit all of the outbound rules of all their ancestors.

An Object-Oriented Modeling Tool: Redefinition of Rules or “Overwrite”

Overwriting rules is done with the objective of reproducing all the OO technology so that the Engine has all the characteristics of a virtual machine.

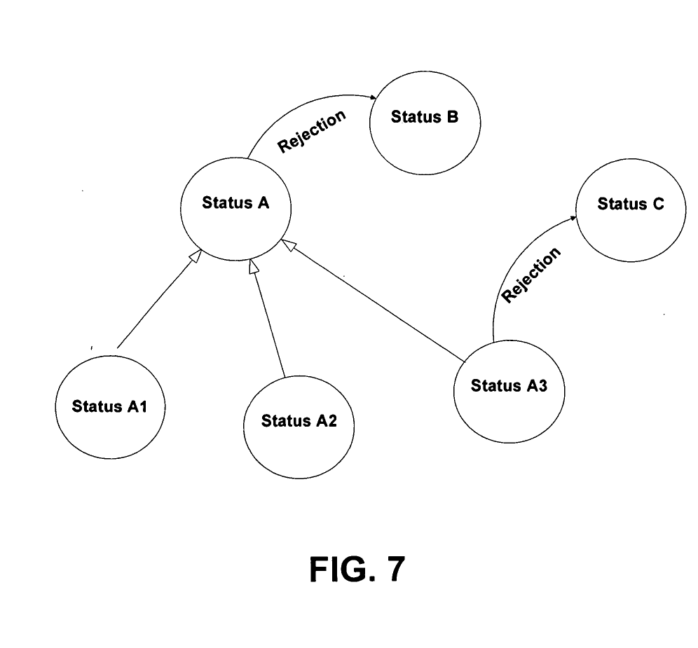

For example, in FIG. 7 there is status A, which has three sub-statuses A1, A2, and A3. Status A has an outbound rule Rejection towards status B. Because of inheritance, the sub-statuses A1, A2, and A3 also contain this rule Rejection towards status B, even though it is not explicitly drawn. Therefore, a Rejection event applied to a token in status A1 changes the token to status B.

But what should be emphasized in this illustration is that status A3 also has its own Rejection outbound rule. Where should a token in this status go if the event Rejection happens to it, to status B or to status C? That is, which rule should be executed, the parent's outbound rule or the child's outbound rule? The answer is the outbound rule of the child status prevails and is therefore executed. A token in status A3 passes into status C. This is called “overwrite,” and it is a main characteristic of OO technology. OO virtual machines use it every time they are asked to execute a method. In the case of the Engine, rules are equivalent to the methods in object-oriented technology. The search for a rule begins with the status where the token resides at a given point in time. If the rule is not found, then the next step is to look it up in the parent's status. If the rule is still not found in all the hierarchy of ancestors, then the rule does not apply.

An Object-Oriented Modeling Tool: Polymorphism

Polymorphism is another fundamental characteristic of an object-oriented technology engine. Two objects are polymorphic if they respect the same group of methods. Methods are grouped in interfaces. Thus, two objects are polymorphic if they respect at least one interface in common. In the present discussion, two statuses are polymorphic if they share the same outbound rules.

Embodiments of the present invention support an Application Process Interface (“API”) named Generate Event that uses this characteristic. It is extremely useful when doing systems integration. The API Generate Event is called with the following specified: user who calls, event to execute, and affected token. The status of the token is of no significance and therefore is not specified.

It does not matter to which workflow (understood as a status and events diagram with parameters) the token belongs. If an API is invoked for a token placed in a status that does not have an event to execute in the outbound rules (neither in its own, nor in the rules it inherits), then the API is ignored for that token. This API can be invoked to tokens which are in totally different statuses or that belong to different workflows. By polymorphism, the correct business rule is applied.

These characteristics make embodiments of the present invention comply with every main feature of object-oriented technology. Embodiments enable object re-utilization and enhance business-rule representation. Object-oriented modeling reduces workflow sizes and improves their maintainability.

Visibility and Assignment

One of the more interesting aspects of some embodiments of the present invention is the ability to handle Visibility and Assignment.

“Assignment” is the set of tasks (tokens) that a user has been assigned for management at a certain moment.

“Visibility” is the universe of the token (task) database records that can be seen or consulted by a user at a certain moment. This concept does not include the management permission of these tokens, that is, the fact that a token can be seen by the user does not necessarily mean that he will be able to manage or perform an operation on it. This should not be confused with the ability to configure what fields, attributes, or consultations each user has access to (or visibility of) on each screen, depending on the user's role: that is another ability of embodiments of the present invention. Here, the discussion is about dynamically hiding some records on the basis of complex condition predicates, which are logical statements. This includes consultations, reports, and every instance of use available for each user.

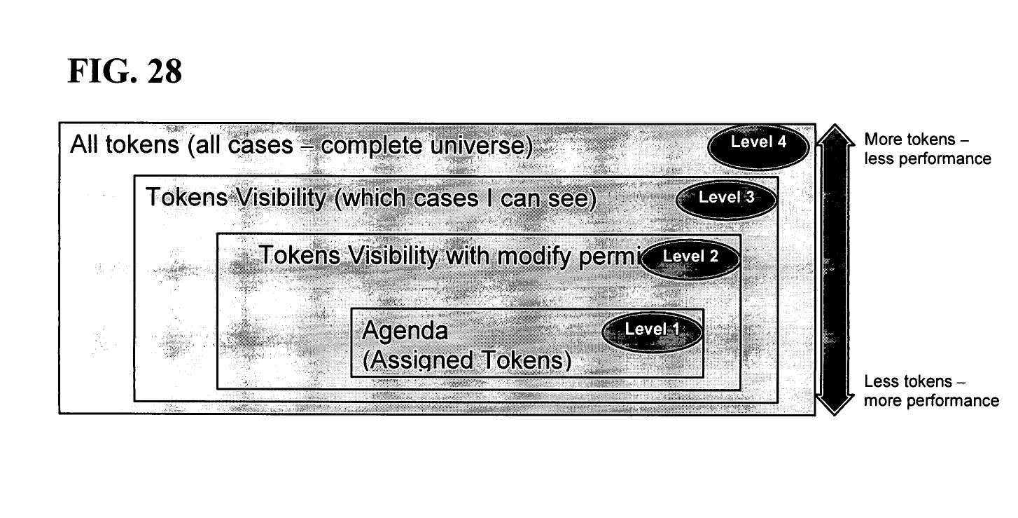

These definitions can be understood as different levels of token subsets. FIG. 28 shows:
In level 1 is the subset with fewer tokens. These are the tokens assigned to a user agenda for management. This level corresponds to the Assignment definition.
In level 2 are all cases in level 1 plus some more. The latter of these are not necessarily assigned to a user, but the user can search, find, and perform operations on them. This level corresponds to the Management definition.
In level 3 are all cases included in level 2 plus some others. The latter of these are those that the user can search and find, see, and analyze, but the user cannot do anything to them. This level corresponds to the Visibility definition.
Level 4 corresponds to the whole token universe. Tokens incorporated in this level do not exist for a user without total visibility.

As an example, imagine a user working in a bank branch. The user is a manager who has to call all clients with complaints pending to be solved.
Level 1: In the user's agenda are twenty cases (tokens).
Level 2: The user's companion has fifteen other cases. This companion is away today. If a client belonging to the companion's agenda calls asking about his complaint, then the user can search this case and perform the needed operation on the system even though that case is not currently assigned to this user.
Level 3: Another client from the user's branch calls asking to cancel his account. The user can take the call and see all of the information but does not have the right to operate on the request.
Level 4: Another client from another branch calls, but the system was configured so that users can only see clients that belong to the same branch to which the user belongs. So this client does not exist for the user.

Visibility and Assignment: How Visibility Works

The thought behind visibility is: on one hand there are users, and, on the other hand, there are tokens. The Builder allows for the configuration of the attributes and the model that surround these two entities. Once the model is correct and the specific business attributes exist, all kinds of logical statements can be specified by the following structure:
Universe of attributes associated with a Token;
Comparison operator; and
Universe of attributes associated with a User.

Once a statement is specified, the definition is controlled in all queries and reports. What a user is able to see is determined by the specified logical statement. Some example statements that can be specified are:
pToken.Region = pUser.Region: “users can see tokens from their own region,”
pToken.customer.CustomerType in (select CustomerType from usersCustomerType where UserId = pUser.userId): “users can see tokens of customer types specified in the User-Customer Type relational table,”
pUser.isSupervisor or pToken.bank.WholesaleRetailer = pUser.WholesaleRetailer: “users can only see tokens of the same bank type (Wholesale or Retailer) unless they are supervisors,”
pToken.AvgConsumption < pUser.ConsumptionLimit: “users can see tokens with average consumption less than the consumption limit specified for them.”
   In these examples, note that the objects used in the logical statements are different in each application. The Builder allows the creation of objects required to specify the statement. These statements are dynamic, and they can change constantly. Therefore, the visibility of the user can change in a dynamic and maintainable way.

Visibility and Assignment: How Assignment Works

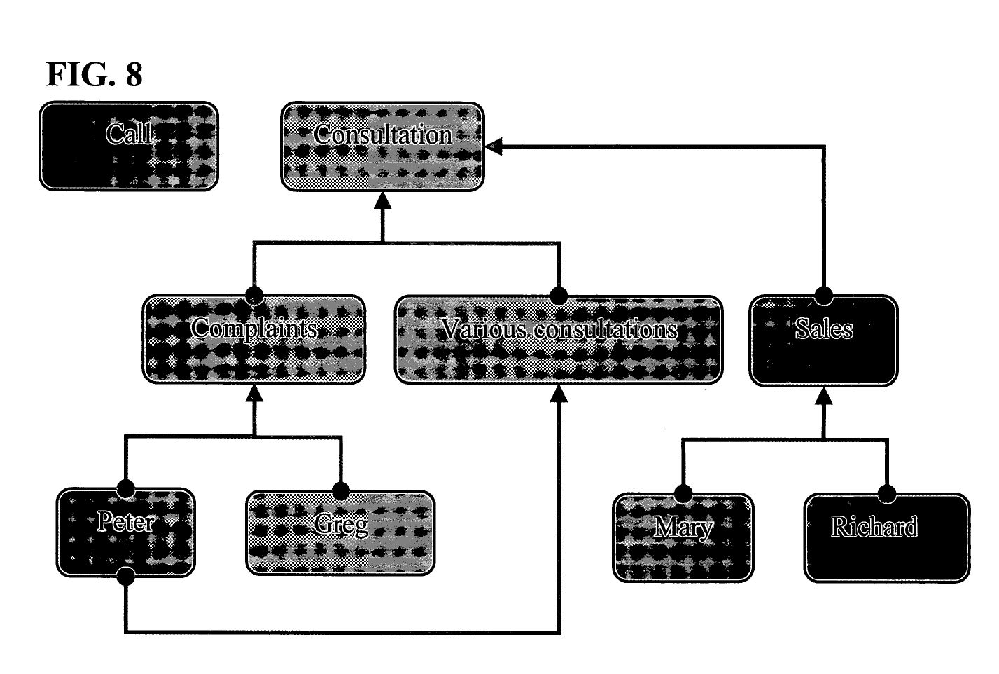

The assignment model allows the user to create sophisticated assignment algorithms. This model is first based on a hierarchy of work-lists or agendas. In FIG. 8 there is an example of work-lists and hierarchy. Note that there are work-lists with names of users, but they are work-lists. The users as entities exist in an independent way. Embodiments of the present invention assign the task to the work-list and not to the user, as they are distinguished as different entities.

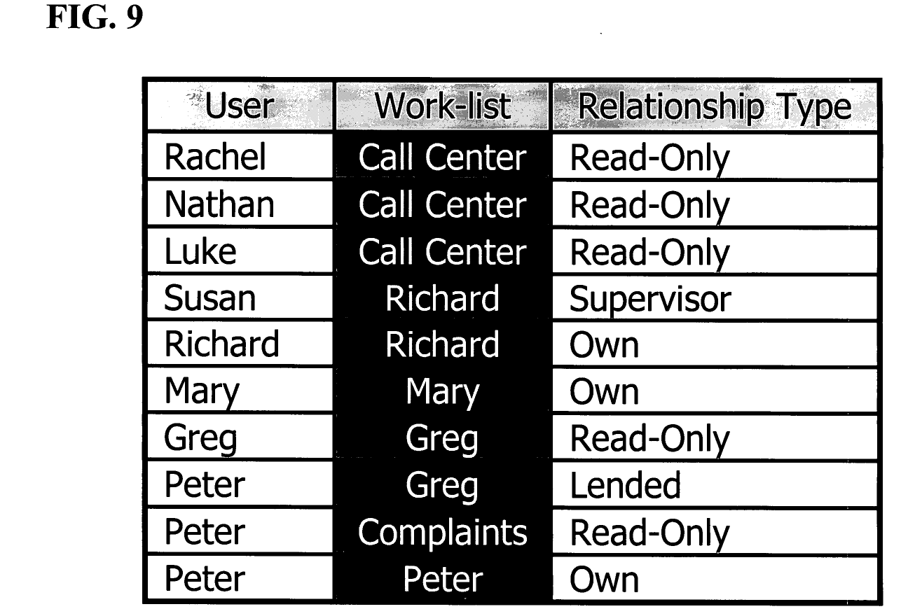

Once the work-lists hierarchy is created, the model keeps on with the users and work-lists relationship. In FIG. 9 there is the relationship between users and work-lists. In the example of FIG. 9:
Rachel, Nathan, and Luke have access to the work-list Call Center. The three of them share and see the same work-list.
Susan and Richard see the work-list of Richard. This is the typical case when supervisors want to see the work-lists of their dependents. With the incorporation of this relationship, Susan can see the same work-list as Richard and control whether he is performing the tasks or not.
Mary can see only her work-list, and she is the only one who can see it.
Greg continues with a similar case, but as he is on vacation, Peter has been granted access to visualize Greg's work-list with a Lent relationship.
Finally, Peter can also see the general work-list Complaints. This is very useful when a supervisor or boss wants to assign himself cases from a common work-list and re-assign them to the people he supervises.

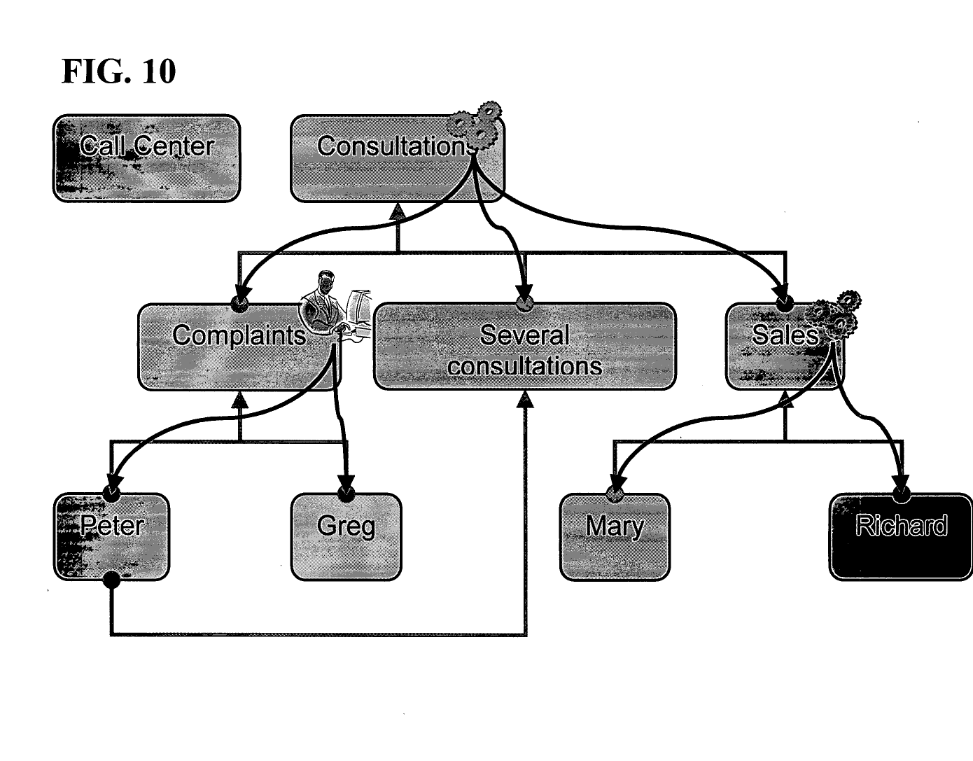

FIG. 10 is an example of a scheme to relate algorithms to work-lists. Each work-list could be associated with an algorithm which intelligently distributes a token into a child work-list. This algorithm can be:
Automatically customizable and
Manual, by a supervisor.
   In this example, the algorithm of the work-list Consultations automatically distributes the task in Complaints, Several Consultations, and Sales according to the statement:
pToken.InquiryType is Complaints thus Work list = Complaints;
pToken.InquiryType is Sales thus Work list = Sales; and
pToken.InquiryType is not Complaints and is not Sales thus Work list = Several Consultations.
   If the token goes to the work-list Complaints, then one person will be able to decide if Peter or Greg should take the task. If it goes to Sales, then another algorithm would apply, for example, a load balancer that always maintains an equal amount of cases assigned to Mary and to Richard.

Visibility and Assignment: Comparison with Prior Technologies

The concept of separating users from agendas and assigning tokens to work-lists and not to users is an aspect of the present invention. In general, prior applications assign tokens to users. This produces countless operating restrictions. The present method provides an organization with several advantages in business-process management maintainability. This is the case of holidays or vacations, absences, supervision, temporary or permanent replacements, training, and shared responsibility of users from different work shifts. The only thing required is to specify which users can access which token work-lists.

For most BPMS products, a user's work-list is composed of tickets (or tasks) that are assigned to him. For some embodiments of the present invention, a user's agenda is composed of all the tokens assigned to the work-lists that he has the privilege to see, joining users and work-lists with different types of relationships. This slight difference is fundamental and makes this technology innovative.

In prior BPMS task-assignment models, it becomes very hard to solve the problems raised by the following questions because the models only provide ad-hoc programming:
Can a user visualize a task assigned to him and assigned to a workgroup?
Can a user take temporary control of tasks assigned to other users in case of vacation, absence, or replacement?
Can users from different work shifts share the responsibility of some tasks without interfering with each other's tasks?
Can a user change a task assignment in such a way that he is the only one who can visualize it and complete it?
Can a group of users ask that the next task assigned to each of them be performed according to management priorities?
Can a user of a superior hierarchy control or even change this operation mode?
Is it possible to make changes on these configuration assignments and apply them immediately after accepting them?
Is it possible to define, just by configuring logical statements, that a specific set of users is able to visualize tasks of the union or the intersection of various different sets of tokens?
Can changes be applied in new task assignments respecting current old task assignments? And not respecting them?

Embodiments of the present invention allow for the defining of user visibility for each and every user according to conditions. Token assignments to hierarchical work-lists are modeled separately.

The Builder—SDK

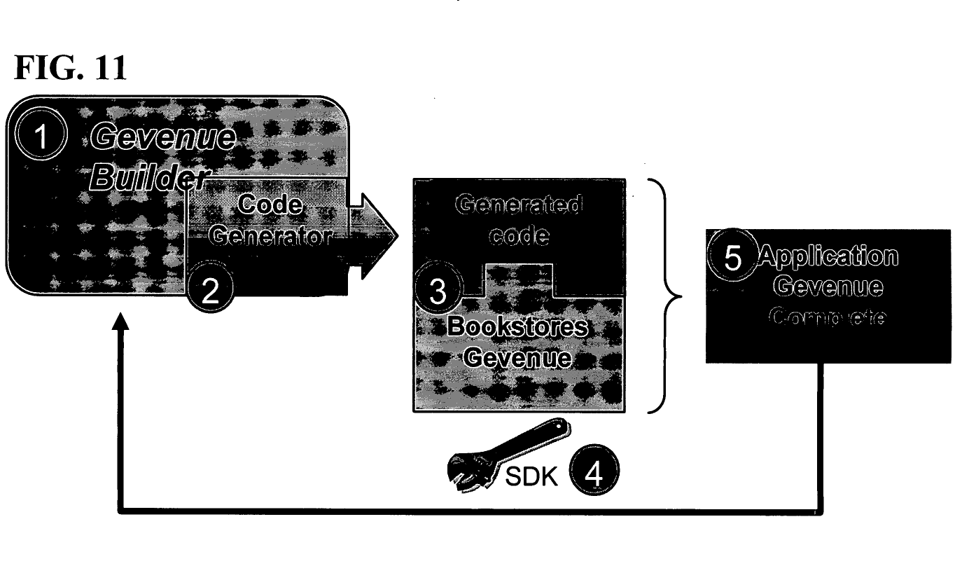

FIG. 11 represents how embodiments of the present invention facilitate the assembling of applications.
The Builder allows for the configuring of an application, reflecting 100% of the customization.
Once the Builder is finished, the Code Generator is executed.
If the generated code is obtained and is combined with libraries, then together they compose the complete application. It is ready to be used.
Optionally, the SDK can be used to modify or extend the generated code or to extend the functionality of the libraries.
Finally, the generated application is compiled. It is then possible to go back with the Builder or SDK in order to perform maintenance.

The code has been carefully designed and divided into layers that encase functionalities according to the case. Embodiments of the present invention have a powerful persistency framework. This framework plus other standard libraries make up the SDK libraries. Other parts of the source code are left open for further modification, if necessary.

The code generated by the Builder fits perfectly over the SDK achieving for the user a complete and customized application in hours. The user is left with the ability to modify any part that is required, without functional limits.

An example Builder configuration includes the following steps.

Configuration of Business Objects: This encompasses not only the creation of the objects, but also their attributes and the relationships between the objects. This configuration is used to generate the scripts for the database and the objects used by an application.

Configuration of System Queries: There are several standard queries that support task and business-process management. The Builder allows for the configuration of each query, indicating columns, orders, filters, and other points based on the business model in the previous step.

Configuration of the Main System Screen Called Consolidated: This is the screen that shows the grouper or owner, with its tokens organized in a tree structure. The Consolidated screen shows the management history of each token, the information associated with the grouper, and each token. The Builder allows for the configuration of every section of this screen according to the business model generated in the first step.

Configuration of Dynamic Forms: This is where Dynamic Forms are defined which can latter be associated with events. These configurations include the complete set of fields with data types, mandatory fields, and data-entry-validation rules.

Configuration of Security: Specified here are which options of the menu each role has access to and what visibility each role will have.

Configuration of Control Boards: This allows for the configuration of the field dimensions to be crossed and the measurements to be calculated along with drill-down views.

Configuration of the Data-Language Dictionary: The Builder is multi-lingual and allows for the translation of each label and description found in the system.

Consolidation of Processes and Systems

The Application Generator can consolidate processes and information from different systems. In organizations, several processes exist that involve a large number of users from multiple systems. Each system usually contains partial information of the company, and the system usually addresses certain processes or specific parts of an entire process. A need exists to consolidate processes from different systems and applications containing dispersed information.

Consolidation: Defining a Particular Business Data Model

The first step in the Builder is defining a model of information. As a starting point, an entity called a grouper and another called a token are defined. The token represents the object of the process to be modeled. It evolves within that same process. The grouper is the entity owner or client of the process, which may be internal or external to the company or organization.

In general, if the process that the token follows does not complete, then the token enters a color-coded state of alarm (red). Hence, the grouper is affected because its process was not successfully completed. For example, if a complaint (a token) is not resolved, then the client (the grouper) will be in disagreement. In another example, if a task (a token) is not completed on time, then the project (the grouper) is affected.

An abstract scheme of customization is shown in FIG. 11. The entities are created and related with the Builder.

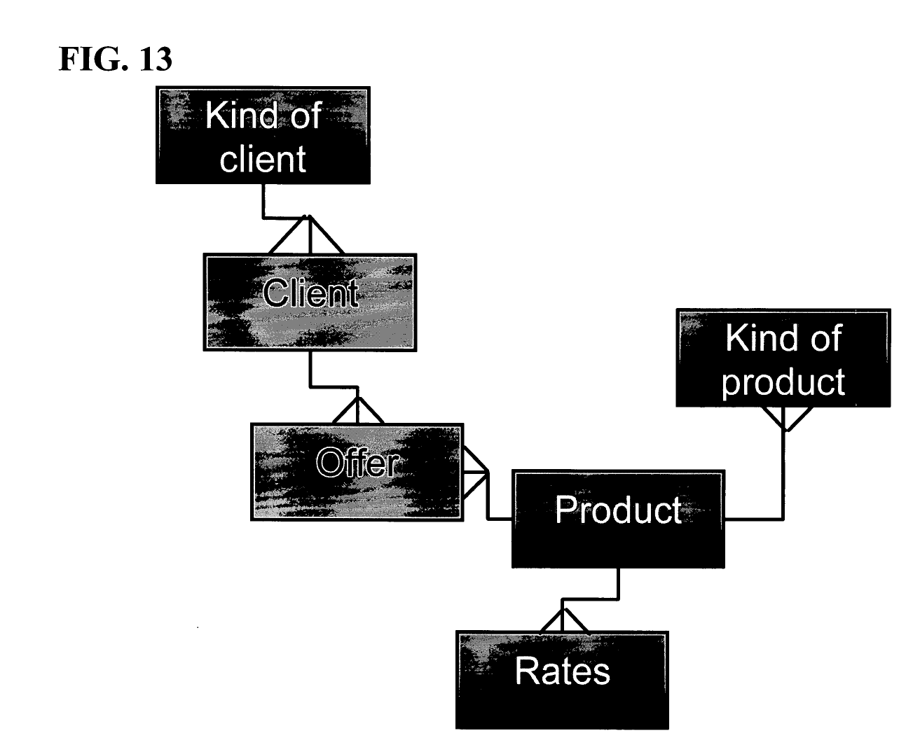

FIG. 13 presents an example of a possible configuration for a business model. In this example, the token is modeled as a sale or as a possible sale (offer), and its grouper is the client. The client is the most common grouper. This occurs in the processes facing an external client, where the client of the process is at the same time the client of the company.

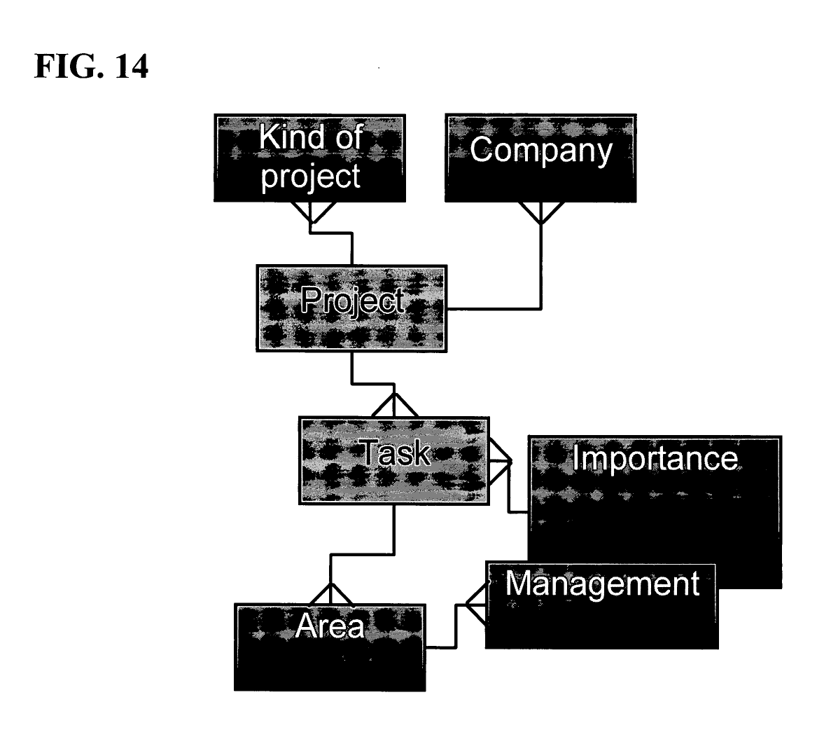

In FIG. 14 another possible example of formatting is demonstrated, where the grouper is the project and the token is a task.

These are simple representations, but embodiments of the present invention can model any kind of business process. The only restriction in the diagram is that at least one grouping entity and at least one entity token exist.

When in the Builder it is indicated that the entity or task (as in the last example) is a token, then the present system through its internal intelligence knows that it must generate information in such a way that it can represent an object that evolves through a process. At the same time the present system is aware of the token's current status, to which workflow it belongs, etc.

These entities can reside in any database. In other words, the present invention supports databases originating from several different standard providers. With that said, the next step is to indicate to each entity where it resides.

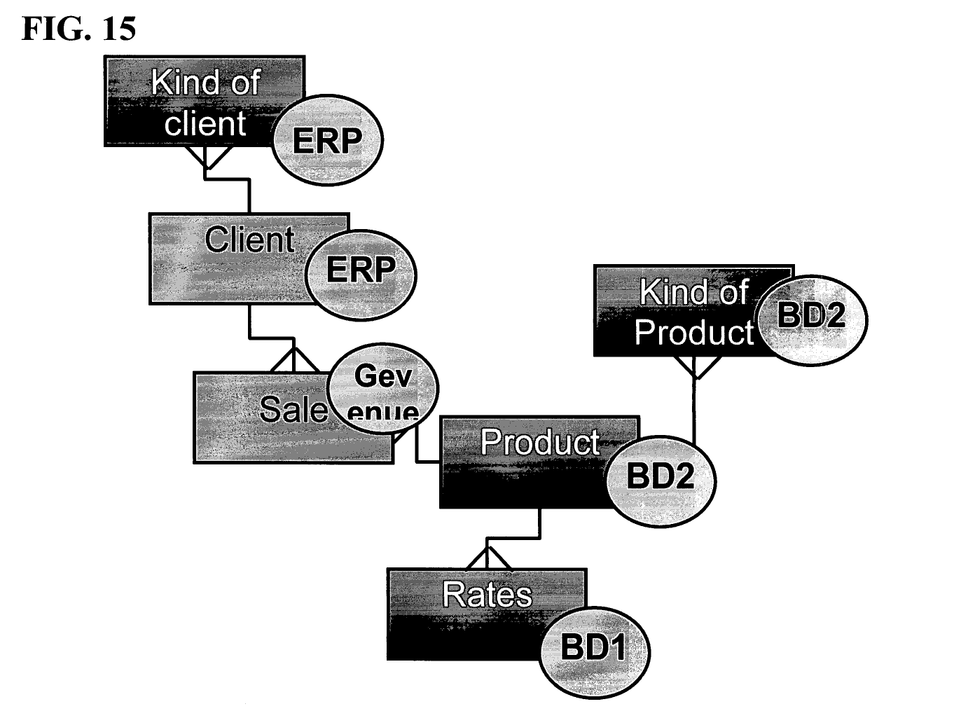

The example of FIG. 15 shows how, through the configuration of the model, it is determined where the entity Sale will reside. The entities that represent tokens reside in the present system, while others reside in external databases such as those pertaining to an ERP (Enterprise Resource Planning). In some cases all the entities reside in the present system, whereas in other cases the majority of the entities reside in external, pre-existing databases.

This function allows for the addition of new functionality to existing systems, without the need to generate interfaces or migration information. Additionally, it allows for the creation of virtual databases that join or merge information from different databases.

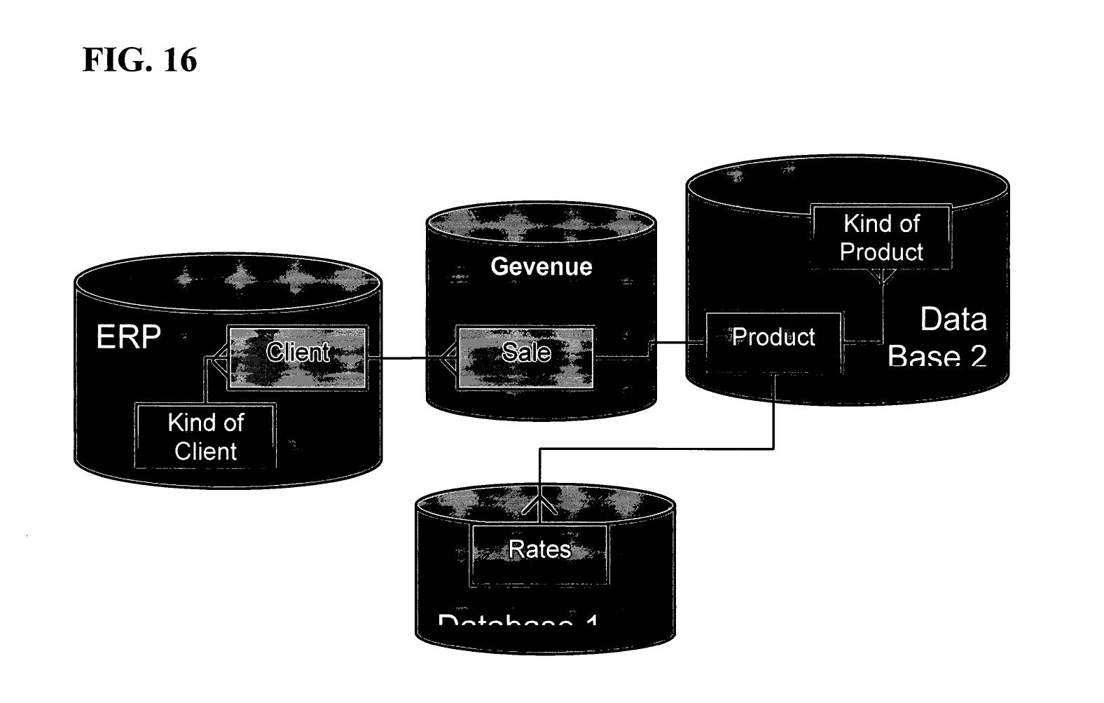

The final result is to obtain a virtual base as shown in FIG. 16.

The final objective is to provide a single view or application interface from which the end user will be able to access integrated management information on-line. This information comes from dispersed systems. Embodiments of the present invention allow an end user to enjoy new functionality in a transparent and user-friendly manner.

The Builder provides modification functionality by guiding the user with simple wizards. This achieves easy customization of the screens which are consolidating the information.

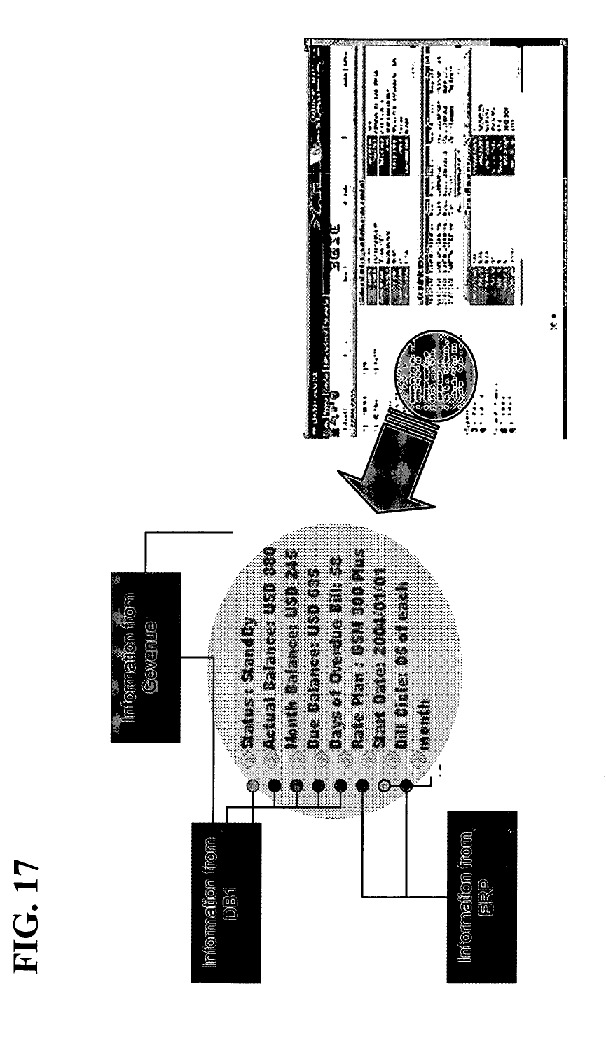

FIG. 17 shows on the left the present system's most significant screen called the Consolidated view. As a component is drilled-down upon, it is maximized. In this view, the present system provides not only the detailed information of the component that resides locally, but also the information from other systems such as an ERP, CRM, or external database.

Consolidation: Comparison with Prior Technologies

Existing database engines and servers provide tools for screen design and behavior configuration. However, they are just tools for facilitating application design and construction. The developer that wants to construct an application and consolidate information from different data sources will have to design and decide on how to handle object size and placement on screens or reports, which still means developing applications. With knowledge of the grouper, the token, and the business model associated, embodiments of the present invention ask simple questions to provide screen customization.

The Builder offers the ability to represent a data model composed of several providers to generate a virtual database. Data can then be arranged easily from the virtual database on the already molded screens through a wizard, and code is generated for a ready-to-use customized BPMS application. The Builder yields the desired configuration of an application being implemented without source-code programming.

Integration

One of the most common problems related to the development of software is integration between existing systems. At some time almost all applications establish dialogue with other applications to interchange data. The present system is capable of integrating information through a visual user interface that avoids complex integration efforts.

It is useful to have responsive and flexible tools to aid in the integration. The need exists as a result of performance issues, encasing, and security. It is clear why it is necessary to maintain the systems separate and to build controlled integrations between existing systems.

With that objective, the present system provides several different alternatives. The following discussion present several characteristics of some embodiments of the present invention: dynamic forms, operations associated to a status, automatic operation-consuming processes, and transferring information from a dynamic form.

Integration: Dynamic Forms

Forms are a set of information to be entered with their validations, values by default, and specific behavior. The forms expand when a user selects the event that he wants to register after performing a management task. Dynamic forms prove useful when associating additional information to the token during the execution of an event.

Using dynamic forms is a way to collect new information in some moment of the process.

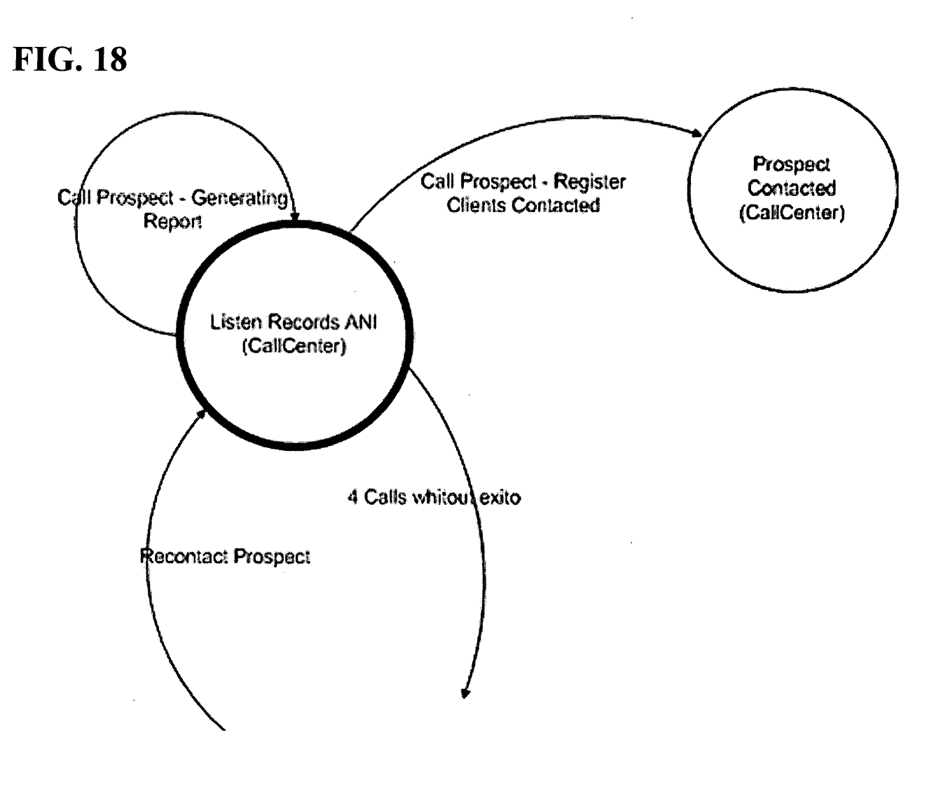

Dynamic forms are associated to an event. To further explain this concept, please see the example of the portion of the process described in FIG. 18. In this example, the management of affiliations to a sports institution is handled. More specifically, it shows how a Call Center could manage the affiliation. Attention is drawn to the process delimited by the objects highlighted with bold lines. The object is “to listen to records ANI (Call Center),” and the two events are “To Contact Prospect” and “Attempt to Call a Prospect.” Suppose that a token resides in the status “to listen to records ANI.” In this case any user of the “Call Center” will know the current status of the token because the application notifies the user that he has a recording that needs to be listened to in the answering machine. At the same time the user is provided with the callback number and reminded that he must register the result when the task is completed. These configurations are a direct result of the business rules that were used to build the model and will vary depending on the business need. In this case there are two possible results configured in the diagram of this particular process: one is “To Contact Prospect” and the other is “Attempt to Call a Prospect.” These results or actions refer to a valid contact and a non-valid contact, respectively.

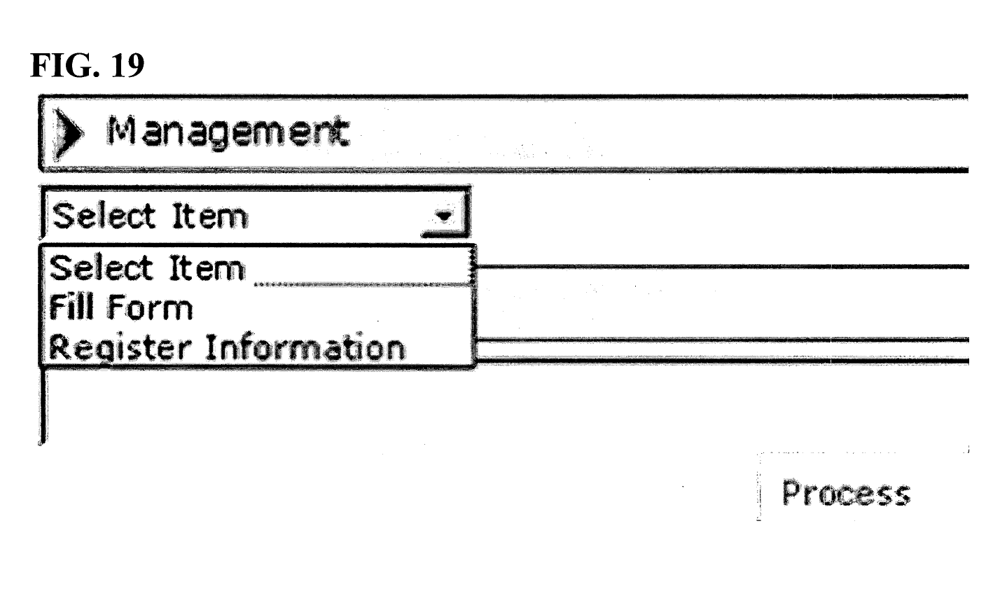

FIG. 19 shows a box of the application where the user registers the management of the example.

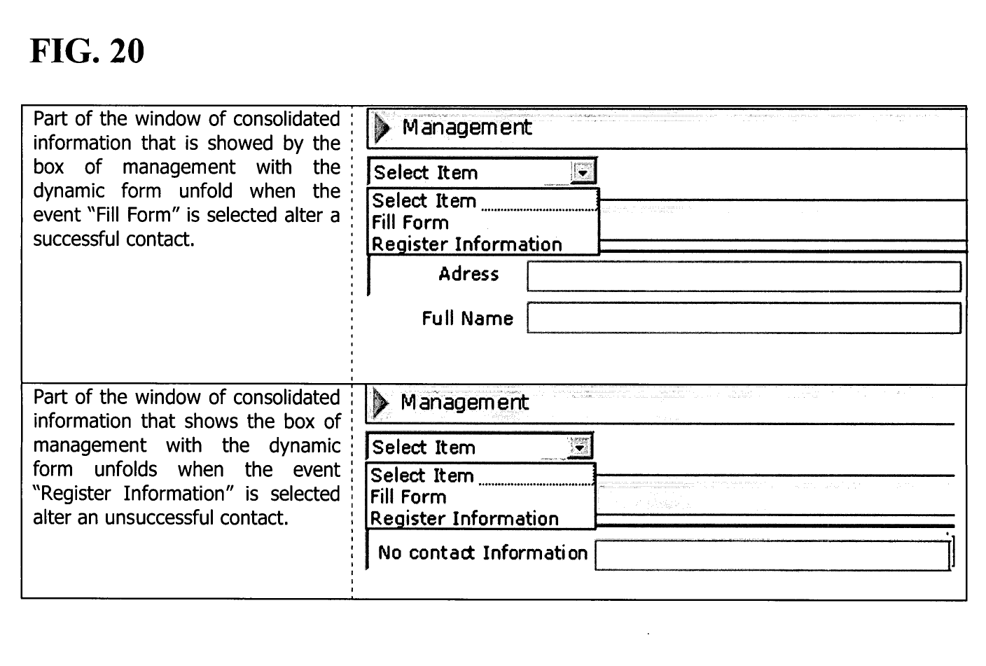

When a user selects an event which has an association with a dynamic form, the form expands to be completed. This occurs before registering the event. Notice that when an event is selected, the rule is not generated, so the token does not change its status. However, a user can select each event as a possible answer. The forms associated with the event will then open at the time they will be selected. See FIG. 20.

Only when the user selects “Register” are the rules generated and the information from the dynamic form recorded on the token. At the same time, the token-status transition is produced. With an optional dynamic form for each event, different information can be saved in the token with different management results. Forms are said to be dynamic because they unfold on the screen when an event is selected; and if the event selection changes before it is registered, then the other forms associated to the new event, if any, unfold dynamically on the screen.

An important point is that dynamic forms have associated metadata, and the present system registers this information as a dynamic form. This information has multiple uses, some of which are discussed below.

Integration: Operation Associated to a Status

There is an attribute associated to the status called “Operation.” An Operation indicates what has to be done when a token enters a certain status. In the example of FIG. 19, the statuses “ESN s/a-Key” and “ESN s/a-Key (Unfulfilled)” have the Operation attribute “enter validation key.” This indicates to the user what management is responsible to do when the token enters that status. The operation is a parameter of the status that can be configured on the same diagram but in this example has been hidden and is therefore not visible. The user selects the “Enter a-Key” event as a management result, the dynamic form unfolds (a parameter of the rule that has been hidden in this diagram too), and then he can enter the key and register the management. When the action is registered, information is added to the token, which in this case is a key.

Integration: Automatic Operation—Consuming Process

There are operations that are consumed by automatic processes of the present invention. The statuses with automatic operations are being monitored constantly by processes called Bridges.

An operation can be as simple as sending an e-mail or as complex as:
suspending an account on another system;
sending an SMS message to a cell phone;
executing a command line;
executing a command on another system; or
sending information to a server in a specified format, for example in XML.

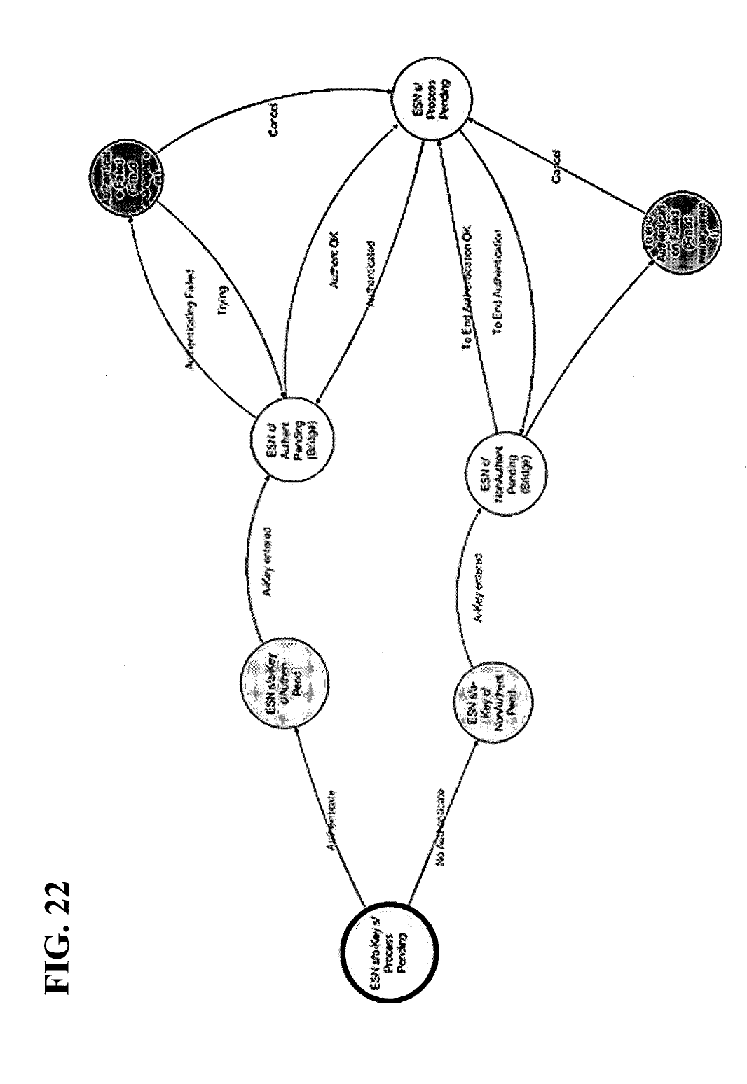

In the process illustrated in FIG. 22, the authentication against a switch of mobile cellular communications equipment with technology CDMA, the statuses “ESN w/Pend Authent” and “ESN w/Pend DesAuthent” have the assigned operation “process authentication key (A-Key) against the switch.” The tokens (cases) that enter in these statuses will already have the authentication key stored. The engine recognizes the operation and calls for the automatic process to consume it. The destination status of the token depends upon the answer received, “OK” or “Failure.” If the answer received is “OK,” then the token moves to the status “ESN s/Pend Process.” In the case of a failed response, the token moves to the applicable status of “Authent Failure” or “DesAuthent Failure.” This is determined according to the branch of the diagram for which the token travels and can be manually verified by an end user of the Fraud Management department.

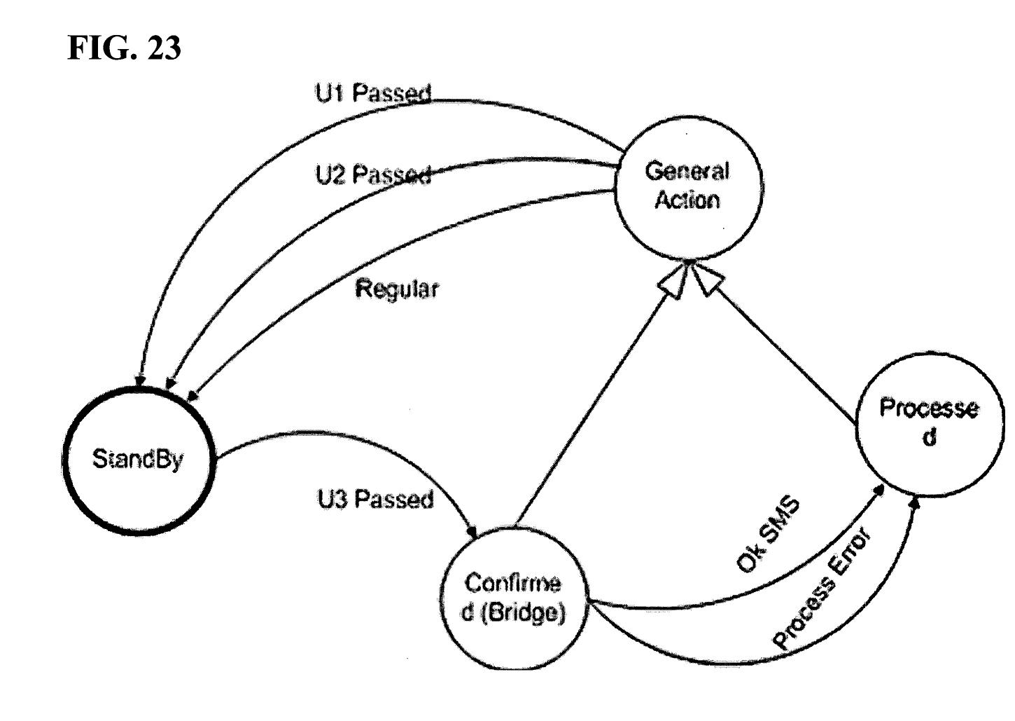

In another example of a credit-limit control process, it is necessary to send an SMS text message to a cell phone when consumption surpasses the established credit limit. The tokens of the diagram of the process in FIG. 23 represent the handling of the warning sent as a result of overcoming the first credit-limit threshold. Tokens entering the status “Confirmed (Bridge)” have the assigned operation “Send SMS” (parameter of configuration hidden in the diagram). That indicates that when a token enters in the status, the operation “Send SMS” will be executed automatically, waiting for an answer from the SMS network system.

When the present system obtains the answer, it executes the corresponding event “SMS OK” or “Error in Processing.” In this example, the two possible transitions (rules of the process) from the origin status and denoted for both events have the same destination status of “Processed.”

Integration: Data Transfer from a Dynamic Form

It is worth emphasizing the capability for transferring information from the present system to other applications using automatic processes and dynamic forms.

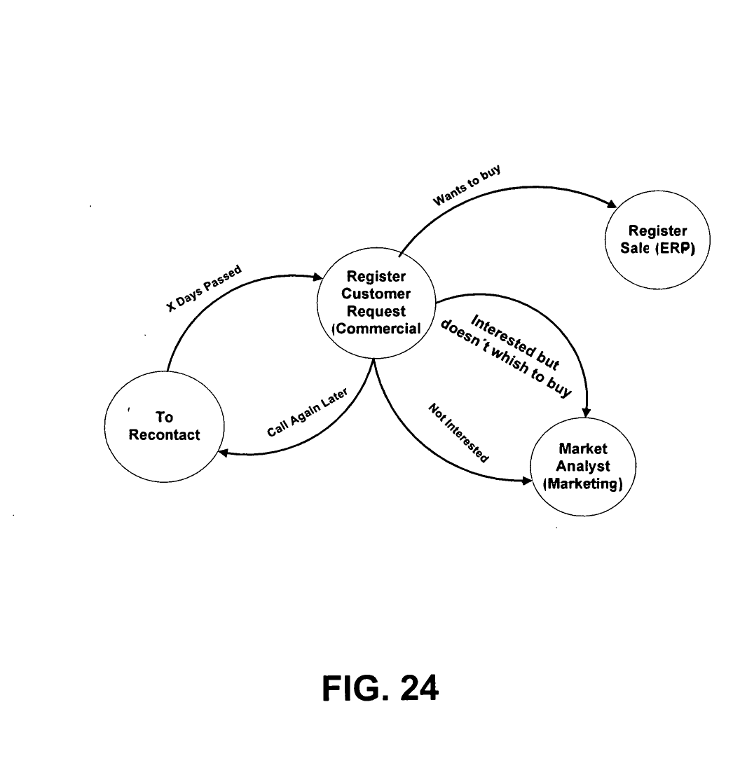

Suppose that a token representing an Offer of Sale enters the status “Register Customer Request” according to the example of FIG. 24. This status represents the moment in which the client is contacted. As defined by the business need, the customer could have one of the following answers: wants to buy, not interested, call again later, interested but does not wish to buy. For each one of these answers it is predetermined that additional information should be entered. For the case of registering an event of “wants to buy,” the information to be entered could be:
product;
amount;
date of delivery; and
place of delivery.
   In the case that the client answer is not interested, the information to be registered is:
how did you know about the campaign?;
reason why the customer is not interested; and
comments.
   In the graph it is shown that when the event “wants to buy” is selected, the token passes to a status “Register Sale,” where the associated work-list is ERP, and its operation is Sale Registration. At this moment the automatic process starts which is able to take the information registered in the dynamic form and transfer it to the ERP system.

A feature of embodiments of the present invention is that when the need exists, the Builder allows the user in a simple and visual way:
to create a dynamic form and
to create an automatic process, indicating what kind it is, if what has to be executed is a Stored Procedure, a line command, to connect to a server with an IP, etc. The Builder also asks about the characteristics of the parallel process to improve the performance and the time of answer.
   Once these components are created in the Builder, it is possible to go to the modeler and use them.

Through the Builder, the BPMS Framework has integration capabilities, and the user can configure them without programming.

Integration: Collecting Information from Users or Systems

Embodiments of the present invention can model a process and associate a dynamic form to an event. This form is responsible for collecting information for the process.

The model is transparent, even if the one responsible to execute the event is a person or a system. For example, the same dynamic form could be used in the same process to allow a user to fill in the information and to allow an external system to send the same information.

Where a process has many manual steps that could be done automatically, it is often not easy to automate each manual step. With the present invention, a user can design the process in an abstract way. The first time, most steps or activities could be done manually. Gradually, manual steps are replaced by automatic steps performed by the system. It is also possible to maintain both the automatic and the manual processes.

To implement this technique, it is not necessary to replace any code. Rather, a new Bridge is generated that consumes some operations and uses as parameters the dynamic form.

Business Model

The present invention provides a Business Model that allows software companies to develop applications with the present BPMS Framework as Business Associates. The Framework includes a powerful engine that automates and controls the management of business processes (the Engine), development tools (the SDK), and application-customization tools (the Builder).

This Business Model is beneficial to clients, channels, or integrators without an operative capacity to develop new applications with the Framework. In this case, clients and integrators are provided with a collection of products which can be customized with the Builder, according to the business needs of any vertical segment of the industry. Examples include manufacturing, utilities, telcos, banking & financial, and energy. Applications can also be developed horizontally by business process: purchases, sales, marketing, logistics, billing, collections, supply, etc.

The Business Model is further described in this section. It is developed by three main roles:
The Company as the centralizing Software Factory;
Business Associates or Franchisees or OSM (Original Software/System Manufacturers): companies with the capacity to develop new applications using the tools and developing products (the SDK) and the customization tools (the Builder); and
Integrators, Distribution Channels, or Distributors of customized applications or solution integrators.

This innovative Business Model allows for the promotion and extension of the of products by the distributing channels or integrators of the Suite.

Business Model: Techno-Comm Network Concept

This component allows the involvement of third-party companies as Business Associates (Franchisees) in the development of new applications, mounted on the Engine and Using the SDK. These companies are added to a network of product developers, promoting their penetration into the market. Major incentives include earnings by selling applications to their own clients and royalties for the use and sale of their developed applications by other distributors of the Techno-Comm Network. These special partners or Business Associates are called Franchises.

In the central role, the Company retains its position as the “product factory.” The product factory has the functions of coordination, administration, and maintenance of the Engine releases, library development, and documentation. Applications in certain thematic areas (collection, sales, etc) are also administered by the product factory.

Distributors are responsible for the direct sale, customization, and implementation of applications. To accomplish these functions, the product factory provides a tool customization kit (the Builder). The kit permits necessary adaptations for the implementation tasks of applications in order to meet the requirements of a particular customer in a thematic area. The kit does not allow for the extension of functionally that would take the application outside the acquired scope.

The following are customization and implementation tasks:
workflow rules configuration (Business Process Modeling);
references configuration;
interface development;
incorporation of additional information fields in agenda inquiries, the events queue, the operations queue, and follow-ups with the Builder; and
configuring additional data entry forms for each event.

The Business Associates/Franchisees handle consulting and assessment functions for the distributors who are involved in the direct sale, customization, and implementation of their developed applications. Likewise, Franchisees develop their own applications in new thematic areas. The product factory is kept in the role of central coordination and development of the Engine. During every stage of the product life cycle in relation with the final client, a certified quality assurance agent from the Company performs quality control on the design of the application. The Company provides Franchisees an SDK tool that allows the integration of new applications with specific functionalities for the target thematic area to the Engine.

These are Franchisee tasks:
develop new applications;
evaluate workflow rules;
implement and revise the Model;
revise Architecture and Interfaces;
recommend Reports Creation; and
assess Implementation Problem Solving.

If a Franchisee qualifies by size and expertise according to the Company's criteria, it can also be awarded the OSM designation. This designation applies to large system manufacturers that can offer their developed applications to a large number of clients. Applications sold by Franchisees with this designation produce extra discounts on the license of use for the Engine and the Builder.

The major benefits for Franchisees include:
access to earning shares for the licensing of their developed applications mounted on the Engine, using the SDK, without additional licensing costs or through a negotiated cost;
the ability to grant their clients user licenses of developed applications in agreement with the conditions of the Company and paying to the Company the corresponding royalty; and
the ability to offer their applications to other members of the Techno-Comm Network (Distributors and Franchisees) and to receive royalties of their user licenses sold by other members of the Techno-Comm Network.

The conditions and major requirements to become a Franchisee can include:
signing the Company's marketing contract;
receiving from the Company the qualification of Integrator Category A, according to the conditions established in the signed marketing contract, with the following minimal principal requirements:
   having at least two SEs (Software Engineer) certified in the Company's products: one for pre-sales and one for professional services delivery;
   the SEs are employees or part of the Integrator A's company infrastructure;
   the SEs meet the requirements for experience and technical profile specified by the Company;
   Integrator A has the responsibility of keeping the SEs updated and trained on the Company's products;
   training costs are shared between Integrator A and the company (travel allowances and expenses are covered by Integrator A, and the Company covers training and related materials);
   Integrator A handles an annual quota and assigned territories; and
   Integrator A agrees to submit to the quality control of the product implementation process at their clients and to the monitoring of their satisfaction; and
signing the Company's franchising contract, with the following additional principal requirements:
   Quality Assurance certified by the Company to guarantee the quality of the whole process of implementation and installation of new applications;
   having at least two SEs certified in the SDK;
   the Company's previous authorization to develop new applications and submission to the regulated quality-control process; and
   the formal ownership of new applications is negotiated between the Company and the Franchisee and is available not only for the Franchisee's clients but also to be offered by distributors through the entire Techno-Comm Network (the payment of license rights or royalties are applied to both the Franchisee for his developed application and also to the Company for the use of the Engine and of the Builder for customization at implementation).

In the Techno-Comm Network, there are combined factors that contribute to promote the technological development of new products (applications) and to the commercialization of these new products. The main elements are:
Cooperation with third-party companies:
   Market penetration is accelerated by newly developed applications, leveraged by the interest in the sale to its clients and to other distributors of the Techno-Comm Network with the consequent royalties benefits.
   In every case the Company supports development of the applications that it considers to be attractive for the Network and certifies the quality of the products and the training of its technical/commercial teams.
The Business Model allows for a dual commercial strategy, the application of the most suitable commercial strategy for each and every distributor depending on its marketing policy and its customers' needs.
   Bottom-Up Strategy (Products by Niches): The “traditional” sale of products individually or combined for niches or vertical markets (e.g., collections, sales, customer care).
   Top-Down Strategy (BPMS Model): A more current and aggressive strategy for business development using the Business Process Management model:
      progressive technology incorporation;
      direct automation of inefficient manual processes;
      the purchase decision belongs to the final user; and
      the benefits are observed immediately.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

1. A business process management system comprising:
a plurality of statuses, at least one of the statuses having a rule defined for it;
a hierarchy defining relationships among the statuses; and
an engine for applying rules;
wherein at least one status in the hierarchy is a child status and has a parent status associated with it;
wherein the child status inherits a rule of its parent status;
wherein the engine, when applying a rule, gives precedence to a rule defined for a child status over a rule defined for the child's parent status, if any; and
wherein the engine can apply a rule for a set of statuses by applying, for each status in the set of statuses, a rule associated with that status.

2. In a business process management system model, a method for providing token visibility and token assignment, the method comprising:
providing visibility for tokens in the model; and
independently of the providing of visibility, providing assignment for the tokens in the model;
wherein the visibility and the assignment are based on customizable dynamic conditions specified by logical statements.

3. The method of claim 2 wherein tokens are assigned into an abstract work-list.

4. A business process management system comprising:
a data model;
a grouper;
a token;
a method for customizing the data model;
a method for accessing the data model from a plurality of data sources, the method for accessing comprising a use of virtual links; and
a method for generating a business process management system application without coding.

5. The business process management system of claim 4 wherein at least one of the plurality of data sources is physically remote from at least one other of the plurality of data sources.

6. A business process management system model comprising:
a form for manually registering a rule wherein the form is executable by an external system and is used as structured data for transferring information; and
a builder for generating forms associated with rules and structured data forms associated with interfaces.

7. A network business model, the network business model comprising:
a software development kit for developing applications;
a builder;
an engine;
a company that centralizes development and that receives license royalties for the use of the engine and the builder;
franchisees that develop applications and that receive royalties for their applications; and
integrators for selling applications.
